(19) United States
(12) Patent Application Publication
(10) Pub. No.: US 2014/0268892 A1
(43) Pub. Date: Sep. 18, 2014

(54) CONVERTER WITH ADJUSTABLE OUTPUT VOLTAGE

(71) Applicant: VOLTRONIC POWER TECHNOLOGY CORP., Taipei City (TW)

(72) Inventors: BANG-HUA ZHOU, SHENZHEN (CN); JIAN-QUN WU, SHENZHEN (CN); JUOR-MING HSIEH, TAIPEI CITY (TW)

(73) Assignee: VOLTRONIC POWER TECHNOLOGY CORP., TAIPEI CITY (TW)

(21) Appl. No.: 13/803,155

(22) Filed: Mar. 14, 2013

(51) Int. Cl. H02M 3/335; G05F 1/563

(52) U.S. Cl. CPC H02M 3/33592; G05F 1/563
USPC 363/17

(57) ABSTRACT

A converter with adjustable output voltage is coupled to a first power source and a second power source. The converter comprises a transformer, a first conversion circuit, a second conversion circuit, a resonant circuit and a regulating circuit. The first conversion circuit has a plurality of first switch elements, each of the first switch elements is coupled to the transformer. The second conversion circuit has a plurality of second switch elements, and each of the second switch elements is coupled to the transformer. The resonant circuit comprises a first inductor, at least one first capacitor and a second inductor. The first inductor is coupled in series to the transformer, and the first capacitor is coupled in parallel to the second conversion circuit. The second inductor is coupled to the first capacitor. The regulating circuit is coupled between the second power source and the second conversion circuit.

### BACKGROUND OF THE INVENTION

1. Field of the Invention

The present invention relates to a converter with adjustable output voltage; in particular, to a converter with adjustable output voltage about reducing power consumption.

2. Description of Related Art

Recently, for the reason to achieve application of resonance, one of the converter circuits at transformer two-sides is mostly re-coupled with a regulating circuit such as a Boost, a Buck or a Buck/Boost circuit.

When a general converter with adjustable output voltage is in operation, power loss exists in a transmission process via the converter with adjustable output voltage. Thus the design that one of the converter circuits at transformer two-sides is coupled with a regulating circuit will increase the circuit complexity. However, the complex circuit design raises the power loss, productive cost or something else.

### SUMMARY OF THE INVENTION

The object of the present invention is to provide a converter with adjustable output voltage, wherein a Boost, a Buck or a Buck/Boost circuit is formed by means of the first capacitor, the second capacitor and a regulating circuit in an LCL resonant circuit. Thereby the relative ratio between input and output voltage is adjusted, and thus the power transfer efficiency of the converter with adjustable output voltage is increased.

In order to achieve the aforementioned objects, according to an embodiment of the present invention, a converter with adjustable output voltage is coupled between a first power source and a second power source and comprises a transformer, a first conversion circuit, a second conversion circuit, a resonant circuit and a regulating circuit. The first conversion circuit has a plurality of first switch elements, and each of the first switch elements is coupled to the transformer. The second conversion circuit has a plurality of second switch elements, and each of the second switch elements is coupled to the transformer. The resonant circuit comprises a first inductor, at least one first capacitor and a second inductor. The first inductor is coupled in series to the transformer, and the first capacitor is coupled in parallel to the second conversion circuit. The second inductor is coupled to the first capacitor. The regulating circuit is coupled between the second power source and the second conversion circuit. The regulating circuit comprises a third switch element and a fourth switch element. The third switch element is coupled in parallel to the first capacitor. The fourth switch element is coupled between the second power source and the second inductor.

In one embodiment of the present invention, the third switch element above mentioned comprises a switch and a diode coupled in parallel to the switch; the fourth switch element above mentioned comprises a switch and a diode coupled in parallel to the switch.

In one embodiment of the present invention, the third switch element aforementioned comprises a switch and a diode coupled in parallel to the switch; the fourth switch element above mentioned is a diode.

In one embodiment of the present invention, the third switch element above mentioned is a diode; the fourth switch element above mentioned comprises a switch and a diode coupled in parallel to the switch.

In one embodiment of the present invention, the first inductor above mentioned is the leakage inductor of a transformer.

In one embodiment of the present invention, the first conversion circuit aforementioned is a full-bridge circuit, a half-bridge circuit or a push-pull circuit.

In one embodiment of the present invention, the second conversion circuit above mentioned is a full-bridge circuit, a half-bridge or a push-pull circuit.

In one embodiment of the present invention, each of the first switch element above mentioned comprises a switch and a diode coupled in parallel to the switch; each of the second switch element above mentioned comprises a switch and a diode coupled in parallel to the switch.

In one embodiment of the present invention, the current above mentioned flows from the first power source to the second power source, at least one of the first switch elements is in on-state, so that the first conversion circuit discharges through a transformer; at least one of the second switch elements is in on-state, so that the second conversion circuit is charged. The on-state period of at least one switch of the first switch elements is roughly equal to the resonant period of the first inductor and at least one of the first capacitors; and the current is limited by the first inductor of the resonant circuit, thus the power loss is reduced.

In one embodiment of the present invention, the current above mentioned flows from the second power source to the first power source, at least one of the first switch elements is in on-state, so that the first conversion circuit is charged through the transformer; at least one of the second switch elements is in on-state, so that the second conversion circuit is discharged. The on-state period of at least one diode of the first switch elements is roughly equal to the current resonant period of the resonant circuit, and the power loss is reduced when the current oscillates to a zero value or to a value approaching zero.

In one embodiment of the present invention, when at least one switch of the first switch elements above mentioned is in on-state, at least one switch of the second switch elements is in off-state; when at least one switch of the first switch elements is in off-state and the diode in parallel is in on-state, at least one switch of the second switch elements is in on-state.

To sum up, based upon the above, the basic operation principle of the converter with adjustable output voltage in the present invention is based on a circuit design that controls the first converter circuit and the second converter circuit at transformer two-sides to achieve a bi-directional or unidirectional flow of current, furthermore a Boost, a Buck or Buck/Boost circuit is formed by the first capacitor, the second inductor and a regulating circuit, so as to adjust the ratio relationship of the input and output voltage. Thereby the opportunity of increasing the power transfer efficiency of a converter for outputting a voltage is enhanced.

In order to further understand the present invention, the following embodiments are provided along with illustrations to facilitate the disclosure of the present invention.

### BRIEF DESCRIPTION OF THE DRAWINGS

FIG. 1 shows a circuit diagram of a converter with adjustable output voltage circuit according to an embodiment of the present invention;

FIG. 2A shows the illustration of operation according to an embodiment of the present invention;

FIG. 2B shows the illustration of operation according to an embodiment of the present invention;

FIG. 2C shows the illustration of operation according to an embodiment of the present invention;

FIG. 2D shows the illustration of operation according to an embodiment of the present invention;

FIG. 3 shows a circuit diagram of a converter with adjustable output voltage circuit according to another embodiment of the present invention;

FIG. 4 shows a circuit diagram of a converter with adjustable output voltage circuit according to another embodiment of the present invention;

FIG. 5 shows a circuit diagram of a converter with adjustable output voltage circuit according to another embodiment of the present invention;

FIG. 6 shows a circuit diagram of a converter with adjustable output voltage circuit according to another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### First Embodiment

FIG. 1 shows a circuit diagram of a converter with adjustable output voltage circuit according to an embodiment of the present invention. Please refer to FIG. 1, a converter 1 with adjustable output voltage is coupled between a first power source P1 and a second power source P2, and the converter comprises a transformer 10, a first conversion circuit 11, a second conversion circuit 12, a resonant circuit and a regulating circuit 16. The converter 1 with adjustable output voltage in the present invention can transfer power bi-directionally, for example, power can be transferred from the first power source P1 to the second power source P2, wherein the regulating circuit 16 has the efficacy of raising a voltage; or the power can be transferred form the second power source P2 to the first power source P1, wherein the regulating circuit 16 has the efficacy of reducing a voltage, thereby a certain ratio relationship between the input and output voltage is generated. Wherein the circuit which is constituted by the capacitor 14, inductor 15 and the regulating circuit 16 is such as the Boost/Buck circuit. The Boost circuit is the situation of taking off the switch S12 base on the above circuit. And the Buck circuit is the situation of taking off the switch S10 base on the above circuit.

In other embodiments, the converter 1 with adjustable output voltage in the present invention may transfer power uni-directionally, for example, power is transferred from the first power source P1 to the second power source P2, wherein the regulating circuit 16 has the efficacy of raising the voltage. In order to illustrate conveniently, in the embodiment the converter 1 with adjustable output voltage is illustrated with bi-directional power transfer, and the embodiment doesn't limit the type of the converter 1 with adjustable output voltage.

The transformer 10 comprises a primary winding N1 and a secondary winding N2 mutually coupled magnetically. In practice, the transformer 10 transfers or converts power through the magnetically coupled primary winding N1 and the secondary winding N2. For example, the transformer 10 reduces the voltage by means of the fact that the number of primary winding N1 is larger than the secondary winding N2. For example, the transformer 10 may reduce the voltage from 120V to 12V. Actually, the number of primary winding N1 can be equal or less than the number of secondary winding N2, thereby the transformer 10 transfers power or raises voltage. The embodiment doesn't limit the type of the transformer 10 and the rest parts are identical, so they will not be described here.

The first conversion circuit 11 has a plurality of first switch elements 111, 112, 113, 114, and those first switch elements 111, 112, 113, 114 comprise respectively a switch S1, S2, S3, S4 and a diode D1, D2, D3, D4 coupled in anti-parallel with the switch S1, S2, S3, S4, each of the first switch elements 111, 112, 113, 114 is coupled to the primary winding N1 of transformer 10.

In practice, the first switch elements 111, 112, 113, 114 are used to control the first conversion circuit 11 to be in on-state or off-state, whereby the first conversion circuit 11 may discharge or be charged. The switches S1, S2, S3, S4 of the first switch elements 111, 112, 113, 114 are coupled in anti-parallel with the diodes D1, D2, D3, D4. Thus the diodes D1, D2, D3, D4 are in on-state when the switches S1, S2, S3, S4 are in off-state, or the diodes D1, D2, D3, D4 are in off-state when the switches S1, S2, S3, S4 are in on-state. The first switch elements 111, 112, 113, 114 are in on-state or off-state by controlling the switches S1, S2, S3, S4, and the switches S1, S2, S3, S4 are implemented by power transistors or field-effect transistors. The embodiment doesn't limit the types of the first switch elements 111, 112, 113, 114, the switches S1, S2, S3, S4 and the diodes D1, D2, D3, D4.

The second conversion circuit 12 has a plurality of second switch elements 115, 116, 117, 118, and those second switch elements 115, 116, 117, 118 comprise respectively a switch S5, S6, S7, S8 and a diode D5, D6, D7, D8 coupled in anti-parallel with the switch S5, S6, S7, S8, each of the second switch elements 115, 116, 117, 118 is coupled to the secondary winding N2 of the transformer 10.

In practice, the second switch elements 115, 116, 117, 118 are used to control the second switch circuit 12 to be in on-state or off-state, whereby the second conversion circuit 12 may discharge or be charged. The switches S5, S6, S7, S8 of the second switch elements 115, 116, 117, 118 are coupled in anti-parallel with the diodes D5, D6, D7, D8. Thus the diodes D5, D6, D7, D8 are in on-state when the switches S5, S6, S7, S8 are in off-state; or the diodes D5, D6, D7, D8 are in off-state when the switches S5, S6, S7, S8 are in on-state. The second switch elements 115, 116, 117, 118 are in on-state or off-state by controlling the switches S5, S6, S7, S8, and the switches S5, S6, S7, S8 are implemented by the power transistors or field-effect transistors. The embodiment doesn't limit the types of the second switch elements 115, 116, 117, 118, the switches S5, S6, S7, S8 and the diodes D5, D6, D7, D8.

To explain in detail, when the first conversion circuit 11 is discharging, power is transferred or converted through the primary winding N1 or secondary N2 of transformer 10, thereby the second conversion circuit 12 is charged. Oppositely, when the first conversion circuit 11 is charged, power is transferred or converted through the primary winding N1 or the secondary winding N2 of transformer 10, thereby the second conversion circuit 12 discharges. Furthermore, the first conversion circuit 11 is a full-bridge circuit and the second conversion circuit 12 is also a full-bridge circuit, thereby the converter 1 with adjustable output voltage is composed of two full-bridge circuits.

In another embodiment, the first conversion circuit 11 is a full-bridge circuit, a half-bridge circuit or a push-pull circuit, and the second conversion circuit 12 is a full-bridge circuit, a half-bridge circuit or a push-pull circuit, thus the converter 1 with adjustable output voltage is composed. The embodiment doesn't limit the types of the first conversion circuit 11 and the second conversion circuit 12 in FIG. 1.

The resonant circuit comprises a first inductor 13 and at least one first capacitor 14 and a second inductor 15. The first inductor 13 is coupled in series to the secondary winding N2 of transformer 10, and at least one first capacitor 14 is coupled in parallel to the second conversion circuit 12. The second inductor 15 is coupled between the second power source P2 and the second conversion circuit 12. In practice, the converter 1 with adjustable output voltage in this embodiment comprises a LCL resonant circuit design having the first inductor 13, the first capacitor 14 and the second inductor 15

In another embodiment, the resonant circuit may be installed at the primary winding N1 of transformer 10. In order to illustrate conveniently, the embodiment is illustrated by the fact that the resonant circuit is installed at the secondary winding N2 of transformer 10, and the embodiment doesn't limit the type whether the resonant circuit is installed at the primary winding N1 or at the secondary winding N2 of transformer 10.

To explain in detail, the first inductor 13 is such as a leakage inductance of a transformer and used to limit the current. For instance, the coupling coefficient between the primary winding N1 and the secondary winding N2 of the transformer 10 is less than 1. Some parts of the windings of transformer 10 have no function of voltage conversion and only have a function similar to a current-limiting inductor. The secondary winding N2 of transformer 10 is coupled in parallel to the first capacitor 14, and the first capacitor 14 is such as a resonant capacitor, thereby the first inductor 13 at the secondary winding N2 of transformer 10 and the first capacitor 14 can perform a reciprocating operation of charging and discharging. Of course, the second inductor 15 acts as resonant filtering for the first inductor 13 and the first capacitor 14, thereby the LCL resonant circuit can attain a current to limit the power transfer.

When the current flows from the first power source P1 to the second power source P2, at least one of the first switch elements 111, 112, 113, 114 is in on-state to let the first conversion circuit 11 discharge, and the power is transferred through the transformer 10; at least one of the second switch elements 115, 116, 117, 118 is in on-state to let the second conversion circuit 12 be charged, and the on-state period of at least one of switches S1, S2, S3, S4 of the first switch elements 111, 112, 113, 114 is roughly equal to the resonant period of the first inductor 13 and at least one of the first capacitors 14; and the current is limited by the first inductor 13 of the resonant circuit, thus the power loss is deduced.

When the current flows from the second power source P2 to the first power source P1, at least one of the first switch elements 111, 112, 113, 114 is in on-state to let the first conversion circuit 11 charge, and the power is transferred through the transformer 10; at least one of the second switch elements 115, 116, 117, 118 is in on-state to let the second conversion circuit 12 discharge. The on-state period of at least one of diodes D1, D2, D3, D4 of the first switch elements 111, 112, 113, 114 is roughly equal to the current resonant period of the resonant circuit, and the power loss is reduced when the current oscillates to a zero value or to a value approaching zero.

It's worth noting that, when at least one of switches S1, S2, S3, S4 of the first switch elements 111, 112, 113, 114 is in on-state, at least one of switches S5, S6, S7, S8 of the second switch elements 115, 116, 117, 118 is in off-state; when at least one of switches S1, S2, S3, S4 of the first switch elements 111, 112, 113, 114 is off and the diodes D1, D2, D3, D4 coupled in anti-parallel are on, at least one of switches S5, S6, S7, S8 of the second switch elements 115, 116, 117, 118 is in on-state. In practice, in the present invention the bi-directional transfer of current is controlled through the action of switches S1, S2, S3, S4, S5, S6, S7, S8 of the first and the second switch elements 111, 112, 113, 114, 115, 116, 117, 118, and the current is limited by the resonant circuit when the power is transferred each time.

A regulating circuit 16 is coupled between the second power source P2 and the second conversion circuit 12. The regulating circuit 16 comprises a third switch element 161 and fourth switch element 162, wherein the third switch element 161 is coupled in parallel to the first capacitor 14 and the fourth switch element 162 is coupled between the second power source P2 and the second inductor 15.

In this embodiment, the third switch element 161 comprises a switch S10 and a diode D10 coupled in parallel to the switch S10, and the fourth switch element 162 comprises also a switch S12 and a diode D12 coupled in parallel to the switch S12. The first capacitor 14, second inductor 15, third switch element 161 and fourth switch element 162 form a Buck/Boost circuit. When power is transferred from the first capacitor 14 to the second power source P2, a boost circuit is thus formed. When power is transferred from the second power source P2 to the first capacitor 14, a buck circuit is thus formed. Of course, the working principle of the buck circuit and boost circuit in the present invention is similar to a general buck circuit and boost circuit.

To explain in detail, a general regulating circuit is such as a buck, a boost or a buck/boost circuit, thereby the complexity and the power loss of a circuit are increased. The regulating circuit 16 of the present invention is formed by the third switch element 161 and the fourth switch element 162 only. As compared with a general regulating circuit, in the present invention the capacitor and the inductor in a general regulating circuit are replaced by the first capacitor 14 and the second inductor 15, thereby the complexity and power loss of the circuit are reduced and the efficacy of adjusting the output voltage is attained.

In another embodiment, the third switch element 161 comprises a switch S10 and a diode D10 coupled in parallel to the switch S10, and the fourth switch element 162 is a diode D12, thereby the first capacitor 14, second inductor 15 and the regulating circuit 16 form a boost circuit; or the third switch element 161 is a diode D10 and the fourth switch element 162 comprises a switch S12 and a diode D12 coupled in parallel to the switch S12, thereby the first capacitor 14, second inductor 15 and the regulating circuit 16 form the buck circuit. The embodiment doesn't limit the type of the regulating circuit 16.

Based on the above, the working principle of the converter 1 with adjustable output voltage in the present invention is to control the first conversion circuit 11 and the second conversion circuit 12 at two sides of transformer 10, so as to accomplish bi-directional or unidirectional flow of current. Then the Buck, the Boost or the Buck/Boost circuit is formed by the first capacitor 14, the second inductor 15 and the regulating circuit 16 so as to adjust the relative ratio between the input and the output voltage. Consequently, the power transfer efficiency for the converter 1 with adjustable output voltage is increased.

In the following, the operation of the converter with adjustable output voltage is further illustrated. FIGS. 2A, 2B, 2C and 2D are the operation diagram of the converter with adjustable output voltage in the present invention. Please refer to the FIGS. 2A, 2B, 2C and 2D.

The circuit operation of the converter 2 with adjustable output voltage in the present invention is divided into four stages, and the flow direction of current is divided into two conditions. One condition is “the power is transferred from the first power source P1 to the second power source P2” and the first capacitor 24, second inductor 25 and the regulating circuit 26 form the boost circuit; the other is “the power is transferred from the second power source P2 to the first power source P1” and the first capacitor 24, second inductor 25 and the regulating circuit 26 form the buck circuit. In another embodiment, the operation of circuit of the converter 2 with adjustable output voltage is divided into one, two or more stages, and the current direction of the circuit may be further distinguished as a unidirectional transfer condition. The embodiment doesn't limit the operation type of the circuit for the converter 2 with adjustable output voltage.

In the stage 1, the first and the second switch elements 211, 214, 215, 218 are in on-state, the first and the second switch elements 212, 213, 216, 217 are in off-state. As shown in FIG. 2A, when the current flows from the first power source P1 to the second power source P2, the first power source P1 discharges and the current flows from the positive electrode of the first power source P1 to the a point of the primary winding N1 of the transformer 20 through the switch S1 of the first switch element 211, then the current flows out from b point of the primary winding N1 of the transformer 20 to the negative electrode of the first power source P1 through the switch S4 of the first switch element 214. However, in the second power source P2, the current flows out from the c point of the secondary winding N2 of the transformer 20 and then sequentially through a first inductor 23, the diode D5 of the second switch element 215, a first capacitor 24 and the diode D8 of the second switch 218, then the current flows into d point of the secondary winding N2 of the transformer 20. At this moment, the second power source P2 accomplishes charging through the filtering of the second inductor 25.

In the next, the regulating circuit 26 adjusts the output voltage according to the charging current of the second conversion circuit 22, and the charging current flows from the first capacitor 24 to the second power source P2, thereby the switch S12 of the fourth switch element 262 is in off-state, and the switch S10 of the third switch element 261 is controlled to be in on-state or off-state, so that the boost circuit is formed by the regulating circuit 26, the first capacitor 24 and the second inductor 25, thereby the output voltage is adjusted.

To explain in detail, when the diode D12 of the fourth switch element 262 is reversely biased to be off and the switch S10 of the third switch element 261 is on, the second inductor 25 stores the power and the first capacity 24 provides the power to the second power source P2 as shown in FIG. 2A. When the diode D12 of the fourth switch element 262 is in on-state and the switch S10 of the third switch element 261 is in off-state, the second inductor 25 provides the power through the diode D12 to the second power source P2 as shown in FIG. 2B.

In the following, as shown in FIG. 2C, when the current flows from the second power source P2 to the first power source P1, the diodes D1, D4 of the first switch elements 211, 214 are in on-state, the first power source P1 is charged and the current flows out from the negative electrode of the first power source P1 to the b point of the primary winding N1 of the transformer 20 through the diode D4 of the first switch element 214, and the current further flows out from a point of the primary winding N1 of the transformer 20 to the positive electrode of the first power source P1 through the diode D1 of the first switch element 211. However, in the second power source P2 side, the current flows into the c point of the secondary winding N2 of the transformer 20, and the current flows out from the d point of the secondary winding N2 of the transformer 20 and then flows sequentially through the switch S8 of the second switch element 218, a first capacitor 24, a switch S5 of the second switch element 215 and the first inductor 23, then the current flows into the c point of the secondary winding N2 of the transformer 20. At this moment, the second power source P2 accomplishes discharging through the filtering of the second inductor 25.

In the next, the regulating circuit 26 adjusts the output voltage according to the discharging current of the second conversion circuit 22, and the discharging current flows from the second power source P2 to the first capacitor 24, thereby the switch S10 of the third switch element 261 is in off-state, and the switch S12 of the fourth switch element 262 is controlled to be on or off, so that the buck circuit is formed by the regulating circuit 26, the first capacitor 24 and the second inductor 25, thereby the output voltage is adjusted.

To explain in detail, when the diode D10 of the third switch element 261 is reversely-biased to be off and the switch S12 of the fourth switch element 262 is on, the second inductor 25 stores the power as shown in FIG. 2C. When the diode D10 of the third switch element 261 is on and the switch S12 of the fourth switch element 262 is off, the second inductor 25 releases the power as shown in FIG. 2D. From the above, it is known that in the present invention the action of the switches S10, S12 of the regulating circuit 26 is controlled to adjust the output voltage.

It is worth noting that the on-state period of the switches S1, S4 of the first switch elements 211, 214 is equal to the resonant period of the first inductor 23 and the first capacitor 24, thus when the switches S1, S4 of the first switch elements 211, 214 is on, the current value will be very small because of the current-limiting function of the first inductor 23. Likewise, the on period of diodes D1, D4 of the first switch elements 211, 214 is exactly equal to the resonant period, thus when the switches S1, S4 of the first switch elements 211, 214 are off and the diodes D1, D4 coupled in anti-parallel are on, the current oscillates to zero or a small value approaching zero, so that the current of circuit is small when the switches S1, S4 of the first switch elements 211, 214 are off or on, thereby the power loss is small for the first switch elements 211, 214.

Certainly, when the switches S1, S4 of the first switch elements 211, 214 are on, the switches S5, S8 of the second switch elements 215, 218 are off, thereby the first conversion circuit 21 is charged and the second conversion circuit 22 discharges. Likewise, when the switches S1, S4 of the first switch elements 211, 214 are off, the switches S5, S8 of the second switch elements 215, 218 are on, thereby the first conversion circuit 21 discharges and the second conversion circuit 22 is charged. From the above, it is known that in the present invention the first conversion circuit 21 and the second conversion 22 at two sides of the transformer 20 are controlled to accomplish the bi-directional transfer of current.

In stage 2, all the switches S1, S2, S3, S4, S5, S6, S7, S8 of the first and the second switch elements 211, 212, 213, 214, 215, 216, 217, 218 are off. No power is transferred at two sides of the transformer 20. If the transformer 20 is viewed as an ideal transformer, then current will not flow through the two sides of the transformer 20.

In the same way, the working principle in stage 3 is mostly similar to stage 1. For example, the first conversion circuit 21 is charged and the second conversion circuit 22 discharges; or the first conversion circuit 21 discharges and the second conversion circuit 22 is charged, wherein the first and the second switch elements 212, 213, 216, 217 are on and the first and the second switch elements 211, 214, 215, 218 are off, and the other part is same as the above, so it will not be described here.

In the same way, the circuit operation of stage 4 is similar to that of stage 2, and after stage 4, the circuit operation will recycle back to stage 1, thus a cycled operation is performed and so on.

To sum up the above and refer to FIG. 1, the converter 1 with adjustable output voltage accomplishes automatically power transfer according to a voltage relation of the first power source P1 and the second power source P2. Assume the number of windings from a point to b point of the primary winding N1 of transformer 10 is W1, the number of windings from c point to d point of the secondary winding N2 of transformer 10 is W2, the voltage of the first power source P1 is Vdc1, and the voltage of the second power source P2 is Vdc2. When Vdc1/W1>Vdc2/W2, the power is transferred from the first power source P1 to the second power source P2, and when Vdc1/W1<Vdc2/W2, the power is transferred from the second power source P2 to the first power source P1.

The working principle of the converter 2 with adjustable output voltage is controlling the circuit at two sides of transformer 20 to accomplish a bi-directional current flowing. Then the buck, boost or buck/boost circuit is formed by the first capacitor 24, the second inductor 25 and the regulating circuit 26 to adjust the relative ratio of the input and the output voltage. Therefore, the power transfer efficiency of the converter 2 with adjustable output voltage is increased.

Moreover, in the present invention the current is limited by resonance when power is transferred each time. When the direction of power transfer is confirmed, it can also be selected that only the switch elements at one side of transformer 20 are controlled and the switch elements at the other side are off, so only naturally conductive currents in the diodes exist. For example, when the power is confirmed to be transferred from the first power source P1 to the second power source P2, then based upon the working principle above only the first switch elements 211, 212, 213, 214 are controlled, and the switches S5, S6, S7, S8 of the second switch elements 215, 216, 217, 218 are kept in off-state.

Summing up the above, the converter with adjustable output voltage in the present invention is designed based on LCL resonant circuit, and the buck, boost, or buck/boost circuit is formed by the first capacitor, the second inductor and the regulating circuit to adjust the relative ratio of the input and the output voltage. Therefore, the power transfer efficiency of the converter with adjustable output voltage is increased.

### Second Embodiment

FIG. 3 shows a circuit diagram of a converter with adjustable output voltage circuit according to another embodiment of the present invention. Please refer to FIG. 3 and FIG. 1. The converter 3 with adjustable output voltage in the second embodiment is similar to the converter 1 with adjustable output voltage in the above first embodiment. For example, the converter 3 with adjustable output voltage can also transfer power bi-directionally. The first capacitor 34, the second inductor 35 and the regulating circuit 36 form the buck/boost circuit. However, there still exists a difference between the converters 3, 1 with adjustable output voltage, and the difference consists in that the first conversion circuit 31 is a half-bridge circuit and the second transfer circuit 32 is a push-pull circuit.

To explain in detail, the converter 3 with adjustable output voltage is based on a resonant circuit design comprising the first inductor 33, the second inductor 35 and the first capacitor 34. The converter 3 with adjustable output voltage also comprises a half-bridge circuit consisted of the first switch elements 313, 314 and the capacitor 311, 312, a push-pull circuit consisted of the second switch elements 315, 316, a transformer 30 and a regulating circuit 36.

Please refer to FIG. 3 again, a primary winding N1 and a secondary winding N2 of the converter 3 with adjustable output voltage are coupled to a first conversion circuit 31 and a second conversion circuit 32 separately, wherein the first conversion circuit 31 is coupled to a first power source P1, the second conversion circuit 32 is coupled to the regulating circuit 36 and the regulating circuit 36 is coupled a second power source P2. The first conversion circuit 31 is the half-bridge circuit that is consisted of the first switch elements 313, 314 and the capacitors 311, 312. The second power source P2 is coupled to the push-pull circuit, consisted of the second switch elements 315, 316, through the first inductor 33, the second inductor 35 and the first capacitor 34.

To explain in detail, the first inductor 33 is coupled between the e point of the secondary winding N2 of the transformer 30 and the second inductor 35, the second switch element 315 is coupled between the c point of the secondary winding N2 of the transformer 30 and the first inductor 34, and the second switch element 316 is coupled between the d point of the secondary winding N2 of the transformer 30 and the first inductor 34. The working principle of the converter 3 with adjustable output voltage is as follows. The capacitor 312 and the first switch elements 313 are on, and the capacitor 311 and the first switch elements 314 are off; or the capacitor 311 and the first switch elements 314 are on, and the capacitor 312 and the first switch elements 313 are off. The other part is same as the above, so it will not be described here.

Excepting the difference above, all the persons skilled in the art should know that the operation of the second embodiment is actually equivalent to the first embodiment. After the first embodiment and the above difference are referred, the operation of the second embodiment will be easily inferred, so it will not be described here.

### Third Embodiment

FIG. 4 shows a circuit diagram of a converter with adjustable output voltage circuit according to another embodiment of the present invention. Please refer to FIG. 4 and FIG. 1. The converter 4 with adjustable output voltage in the third embodiment is similar to the converter 1 with adjustable output voltage in the above first embodiment. For example, the converter 4 with adjustable output voltage can also transfer power bi-directionally, and the first capacitors 44, 45, the second inductor 46 and the regulating circuit 47 form the buck/boost circuit. However, there still exists a difference between the converters 4, 1 with adjustable output voltage, and the difference consists in that the first conversion circuit 41 is a push-pull circuit and the second transfer circuit 42 is a half-bridge circuit.

The converter 4 with adjustable output voltage is based on a resonant circuit design comprising the first inductor 43, the second inductor 46 and the first capacitors 44, 45. The converter 4 with adjustable output voltage also comprises a push-pull circuit consisted of the first switch elements 411, 412, a half-bridge circuit consisted of the second switch elements 413, 414, a transformer 40 and a regulating circuit 47.

Please refer to FIG. 4 again, a primary winding N1 and a secondary winding N2 of the converter 4 with adjustable output voltage are coupled to a first conversion circuit 41 and a second conversion circuit 42 separately, wherein the first conversion circuit 41 is coupled to a first power source P1, and the second conversion circuit 42 is coupled to a second power source P2. The positive electrode of the first power source P1 is couples to the e point of the primary winding N1 of the transformer 40, the first switch element 411 is coupled between the c point of the primary winding N1 of the transformer 40 and the negative electrode of the first power source P1, and the first switch element 412 is coupled between the d point of the primary winding N1 of the transformer 40 and the negative electrode of the first power source P1, thereby the push-pull circuit is formed.

The positive electrode of the second power source P2 is coupled through the second inductor 46 to the half-bridge circuit that is consisted of the second switch elements 413, 414 and the first capacitors 44, 45. The half-bridge circuit is coupled through the first inductor 43 to the secondary winding N2 of the transformer 40. The working principle of the converter 4 with adjustable output voltage is: the first and the second switch elements 411, 414 are in on-state, and the first and the second switch elements 412, 413 are in off-state; or the first and the second switch elements 412, 413 are in on-state, the first and the second switch elements 411, 414 are in off-state. The other part is same as the above, so it will not be described here.

Excepting the difference above, all the persons skilled in the art should know that the operation of the third embodiment is actually equivalent to the first embodiment. After the first embodiment and the above difference are referred, the operation of the third embodiment will be easily inferred, so it will not be described here.

### Fourth Embodiment

FIG. 5 shows a circuit diagram of a converter with adjustable output voltage circuit according to another embodiment of the present invention. Please refer to FIG. 5 and FIG. 3. The converter 5 with adjustable output voltage in the fourth embodiment is similar to the converter 3 with adjustable output voltage in the above second embodiment. For example, the first conversion circuit 51 of the converter 5 with adjustable output voltage is a half-bridge circuit and the second conversion circuit 52 is a push-pull circuit. However, there still exists a difference between the converters 5, 3 with adjustable output voltage, and the difference consists in that the fourth switch element 562 of the regulating circuit 56 is a diode, thereby the first capacitor 54, the second inductor 55, the third switch element 561 and the fourth switch element 562 form a boost circuit. Therefore, the power can be uni-directionally transferred only from the first capacitor 54 to the second power source P2.

Excepting the difference above, all the persons skilled in the art should know that the operation of the fourth embodiment is actually equivalent to the second embodiment. After the second embodiment and the above difference are referred, the operation of the fourth embodiment will be easily inferred, so it will not be described here.

### Fifth Embodiment

FIG. 6 shows a circuit diagram of a converter with adjustable output voltage circuit according to another embodiment of the present invention. Please refer to FIG. 6 and FIG. 4. The converter 6 with adjustable output voltage in the fifth embodiment is similar to the converter 4 with adjustable output voltage in the above third embodiment. For example, the first conversion circuit 61 of the converter 6 with adjustable output voltage is a push-pull circuit and the second conversion circuit 62 is a half-bridge circuit. However, there still exists a difference between the converters 6, 4 with adjustable output voltage, and the difference consists in that the third switch element 671 of the regulating circuit 67 is a diode, thereby the first capacitors 64, 65, the second inductor 66, the third switch element 671 and the fourth switch element 672 form the buck circuit. Therefore, the power can be uni-directionally transferred only from the second power source P2 to the first capacitors 64, 65.

Excepting the difference above, all the persons skilled in the art should know that the operation of the fifth embodiment is actually equivalent to the third embodiment. After the third embodiment and the above difference are referred, the operation of the fifth embodiment will be easily inferred, so it will not be described here.

As described above, the circuits at two-sides of the transformer within the converter with adjustable output voltage in the present invention may be implemented with a full-bridge circuit, a half-bridge circuit or a push-pull circuit, and the first capacitor, the second inductor and the regulating circuit may be implemented with a buck, a boost, or a buck/boost circuit. The applicable combination is as follows:

| | | Topology of | Topology of the first |
|---|---|---|---|
| | Topology of the | the second | capacitor, the second |
| Resonant | first conversion | conversion | inductor and the regulating |
| type | circuit | circuit | circuit |
| LCL | Full-bridge | Full-bridge | Buck, Boost, Buck/Boost |
| | | Half-bridge | Buck, Boost, Buck/Boost |
| | | Push-pull | Buck, Boost, Buck/Boost |
| | Half-bridge | Full-bridge | Buck, Boost, Buck/Boost |
| | | Half-bridge | Buck, Boost, Buck/Boost |
| | | Push-pull | Buck, Boost, Buck/Boost |
| | Push-pull | Full-bridge | Buck, Boost, Buck/Boost |
| | | Half-bridge | Buck, Boost, Buck/Boost |
| | | Push-pull | Buck, Boost, Buck/Boost |

Summing up the above, the converter with adjustable output voltage in the present invention is based on a LCL resonant circuit design, and the bi-directional or unidirectional transfer of power is accomplished by controlling the first and the second conversion circuits at two-sides of a transformer. At the same time, a Boost, a Buck or a Buck/Boost circuit is formed by the first capacitor, the second inductor and the regulating circuit, so as to adjust the relative ratio between the input and the output voltage, thus the efficiency of power transfer is increased.

Moreover, when the on-state period of the switch of every switch element in the first and the second conversion circuit is identical to the resonant period of the first inductor and the first capacitor in the resonant circuit, the current value is very small because of the current-limiting function of the first inductor in the resonant circuit. Similarly, when the switches are off-state, the current oscillates to zero or to a small value approaching zero. In this way, the current of circuit is small when the switches are in off-state or on-state. The power loss of the switches is also small and thus the circuit efficiency is increased.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A converter with adjustable output voltage, coupled to a first power source and a second power source, the converter comprising:
a transformer;
a first conversion circuit, having a plurality of first switch elements, each of the first switch elements being coupled to the transformer;
a second conversion circuit, having a plurality of second switch elements, each of the second switch elements being coupled to the transformer;
a resonant circuit, having a first inductor and at least one first capacitor and a second inductor, the first inductor being coupled in series to the transformer, and the at least one first capacitor being coupled in parallel to the second conversion circuit, the second inductor being coupled to the at least one first capacitor; and
a regulating circuit, coupled between the second power source and the second conversion circuit; the regulating circuit comprising a third switch element and a fourth switch element, the third switch element being coupled in parallel to the at least one first capacitor and the fourth switch element being coupled between the second power source and the second inductor.

2. The converter with adjustable output voltage according to claim 1, wherein the third switch element comprises a switch and a diode coupled in parallel to the switch.

3. The converter with adjustable output voltage according to claim 1, wherein the fourth switch element comprises a switch and a diode coupled in parallel to the switch.

4. The converter with adjustable output voltage according to claim 2, wherein the fourth switch element comprises a switch and a diode coupled in parallel to the switch.

5. The converter with adjustable output voltage according to claim 1, wherein the fourth switch element is a diode.

6. The converter with adjustable output voltage according to claim 2, wherein the fourth switch element is a diode.

7. The converter with adjustable output voltage according to claim 1, wherein the third switch element is a diode and the fourth switch element comprises a switch and a diode coupled in parallel to the switch.

8. The converter with adjustable output voltage according to claim 1, wherein the first inductor is leakage inductance of the transformer.

9. The converter with adjustable output voltage according to claim 1, wherein the first conversion circuit is a full-bridge circuit, a half-bridge or a push-pull circuit.

10. The converter with adjustable output voltage according to claim 1, wherein the second conversion circuit is a full-bridge circuit, a half-bridge or a push-pull circuit.

11. The converter with adjustable output voltage according to claim 9, wherein the second conversion circuit is a full-bridge circuit, a half-bridge or a push-pull circuit.

12. The converter with adjustable output voltage according to claim 1, wherein each of the first switch elements comprises a switch and a diode coupled in parallel to the switch, and each of the second switch elements comprises a switch and a diode coupled in parallel to the switch.

13. The converter with adjustable output voltage according to claim 12, wherein the current flows from the first power source to the second power source, and at least one of the first switch elements is on, so that the first conversion circuit discharges and the current flows through the transformer; at least one of the second switch elements is on, thus the second conversion circuit being charged, and the on-state period of at least one switch of the first switch elements being roughly equal to the resonant period of the first inductor and the at least one first capacitors; and the current being limited by the first inductor of the resonant circuit, thus power loss being reduced.

14. The converter with adjustable output voltage according to claim 12, wherein the current flows from the second power source to the first power source, at least one of the first switch elements is on, so that the first conversion circuit is charged and the current flows through the transformer; at least one of the second switch elements is on, so that the second conversion circuit discharges, the on-state period of at least one diode of the first switch elements is roughly equal to the current resonance period of the resonant circuit, and the current oscillates to zero value or to a value approaching zero.

15. The converter with adjustable output voltage according to claim 13, wherein the current flows from the second power source to the first power source, at least one of the first switch elements is on, so that the first conversion circuit is charged and the current flows through the transformer; at least one of the second switch elements is on, so that the second conversion circuit discharges, the on-state period of at least one diode of the first switch elements is roughly equal to the current resonance period of the resonant circuit, and the current oscillates to zero value or to a value approaching zero.

16. The converter with adjustable output voltage according to claim 12, wherein, when at least one switch of the first switch elements is on, at least one switch of the second switch elements is off; when at least one switch of the first switch elements is off and the diode coupled in parallel is on, at least one switch of the second switch elements is on.
